(19) United States
(12) Patent Application Publication
(10) Pub. No.: US 2023/0412767 A1
(43) Pub. Date: Dec. 21, 2023

(54) OBTAINING FEEDBACK IN VIRTUAL MEETINGS

(71) Applicant: Viktor Kaptelinin, Hornefors (SE)

(72) Inventor: Viktor Kaptelinin, Hornefors (SE)

(21) Appl. No.: 18/212,560

(22) Filed: Jun. 21, 2023

Related U.S. Application Data
(60) Provisional application No. 63/354,200, filed on Jun. 21, 2022.

(51) Int. Cl. H04N 7/15; H04L 12/18

(52) U.S. Cl. CPC H04N 7/157; H04N 7/152; H04L 12/1822

(57) ABSTRACT

The present invention teaches methods and software, intended to help a participant in an online meeting to understand other participants more efficiently. According to one embodiment of the invention, a participant in a meeting can initiate a poll, in which a question is asked verbally, and responses are provided by choosing an item from a pop-up dialogue panel. According to another invention, a requesting meeting participant (e.g., a presenter) can enable a monitoring feature, so that other participants can continuously assess the session.

### CROSS-REFERENCE TO RELATED APPLICATIONS

The present application claims the benefit of provisional U.S. Patent Application Ser. No. 63/354,200, filed Jun. 21, 2022 with title “MANAGEMENT OF USER'S INCOMING IMAGES IN VIDEOCONFERENCE SESSIONS” and naming Viktor Kaptelinin as inventor.

### FEDERALLY SPONSORED RESEARCH

Not Applicable.

### BACKGROUND OF THE INVENTION

This invention relates to electronic systems and their interfaces. More specifically, it relates to information technologies that enable communication between several participants connected to each other through a computer network and using teleconferencing technologies, such as videoconferencing technologies, to conduct virtual meetings (such as committee meetings, lectures, seminars, etc.).

In physical meetings, people intuitively use a diversity of perceptual clues and strategies to understand other participants and present themselves to the others. In “virtual meetings” supported by teleconferencing technologies (“virtual meetings” are also referred to as “online meetings”, which terms are used interchangeably in the context of this application), the use of such cues and strategies is limited. A person's usage of teleconferencing technologies during a virtual meeting typically involves voice and/or video communication, based on employing microphones, speakers, displays, and one or more video cameras to capture and transmitting a view (or “image”) of the person (i.e., “user view”) to other participants in the meeting. A potential problem with current teleconferencing systems for virtual meetings is that they do not provide a participant in a meeting with sufficient feedback from other participants.

### SUMMARY OF THE INVENTION

The present invention teaches methods, apparatuses, and software, intended to support a participant in an online meeting session in obtaining feedback from other participants, and thus help the participant (i.e., a user of a videoconferencing technology) to understand other participants and present themselves to others more efficiently. According to one embodiment of the invention, a participant in a virtual meeting can initiate a poll, in which a question is asked verbally, using a conventional functionality of a teleconferencing/videoconferencing system, and responses are provided by choosing an item or items from pop-up dialogue boxes displayed on responders' displays. According to yet another embodiment, a requesting meeting participant (e.g., a presenter) can enable a monitoring feature, so that other participants can select a value of a predefined attribute or attributes, and a collated (combined, integrated, assembled), and preferably anonymous, representations of the selected attribute values are displayed on the display of the requesting participant.

According to an embodiment of the invention, a method is provided for supporting a plurality of users using a plurality of electronic devices to engage in a teleconference session (e.g., “virtual meeting”, “videoconference session” or “online meeting”), said plurality of users comprises a first user and at least a second user, and said plurality of electronic devices comprises at least a first device and a second device, wherein said first user uses said first device and said second user uses said second device, wherein each device in said plurality of devices comprises at least a processor, a display, said display displaying an at least a display window, a microphone, and preferably a video camera configured to be able to capture an image of the first user of said first device, wherein said plurality of devices are connected via a communication network to one another and preferably to a network server or servers, the method comprising the method steps of detecting a user action performed by a user from said plurality of users, said user action being a request for displaying information from said plurality of users (e.g., meeting participants), said requesting user action being performed either before or during said teleconference session; and presenting information from said plurality of users on an electronic device of said information-requesting user, said electronic device being a device from said plurality of devices.

According to an embodiment of the invention, the requesting user action is a question, verbally asked by said first user, using an audio or a video communication channel, to said at least second user (or several users), wherein substantially at the time of asking said question said first participant performs a user action causing displaying a response screen object on at least said second electronic device (or several devices), wherein said response screen object enables at least said second user (or several users) to choose a response to said question through a user action (such as clicking on a certain clickable button), said response of at least second user (or several users) being displayed to said first user (preferably, anonymously) on said display of said first electronic device.

According to another embodiment, the second user (or several users) is provided with a response panel displayed on said second electronic device, to continuously provide responses during said videoconference session or a part of said session, at time or times of their choosing, to dynamically assess an aspect of said videoconference session (such as a presentation given by said first user), wherein said responses, summarized and preferably anonymized, are continuously displayed on said display of said first user.

### BRIEF DESCRIPTION OF THE DRAWINGS

FIG. 1: illustrates, at a high level of abstraction, the method according to the present invention.

FIGS. 6a-6c: Illustrate the first embodiment of the present invention.

FIGS. 7a-7c: Illustrate the second embodiment of the present invention.

FIGS. 8a-8b: Illustrate a ramification of the second embodiment of the present invention.

### DETAILED DESCRIPTION OF THE INVENTION

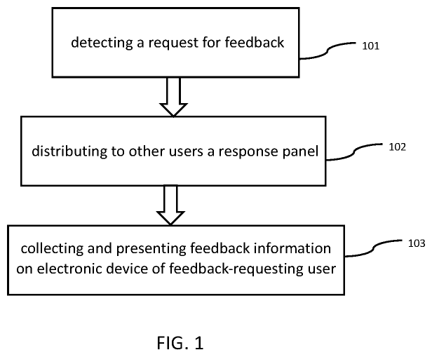

FIGS. 1, 6, and 7 illustrate two embodiments of the present invention. The embodiments are intended to support a participant in an online meeting to help the participant (i.e., a user of a videoconferencing technology) to better understand other meeting participants.

When a person takes part in an online (or “virtual”) meeting, supported by the use of a videoconferencing technology, the person is typically presented with “participant views. There are two types of participant views. First, there are participant views of other participants in the meeting, A participant view of this type comprises information about another meeting participant, received by a person and displayed on the receiving person's device. The second type is a person's “self-view”, that is, a person's view (including, e.g., a video image captured by a person's own camera), which is displayed to the person themselves. A self-view may be used by a person to see how she or he is viewed by other meeting participants. A participant view may not only be a view of one particular person, but it can also be a view of several people, e.g., several people using the same device or the same videoconference-enabled room.

In addition to sending and receiving their views, participants in virtual meetings can also stream other types of images. For instance, a presenter may share an image of a presentation slide or show a video to other participants. In the context of this application, this type of content is referred to as “screen shared”. It is understood that the term “screen-shared” is not limited to content, streamed to other participants using a “screen share” command, but includes various types of media (images and sounds, potentially including other modalities), shared by a meeting participant, and viewed in substantially real time by other meeting participants.

FIG. 1 illustrates a method according to the present invention. A method is provided for supporting a plurality of users using a plurality of electronic devices to engage in a teleconference session, said plurality of users comprises a first user and at least a second user, and said plurality of electronic devices comprises a first device used by said first user and at least a second device used by said at least second user, wherein each device in said plurality of devices comprises at least a processor, a display, said display displaying an at least a display window, a microphone, wherein said plurality of devices are connected via a communication network to one another and preferably to a network server or servers, the method comprising the method steps of

detecting a feedback-requesting user action performed by said first use (step 101), said user action being a request for information from said at least second user, said requesting user action being performed either before or during said teleconference session; wherein said requesting user action causes displaying a response screen panel on said electronic device of said at least second user (step 102); wherein said response panel is adapted to be used by said at least second user to provide information requested by said first user; and

transmitting information collected through the use of said response panel from said at least electronic device used by said at least second user to said electronic device used by said first user users; and presenting said transmitted information on said electronic device used by said first user (step 103).

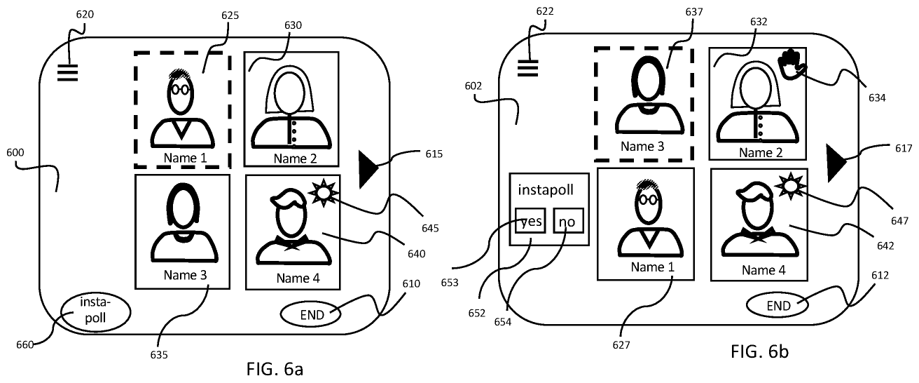

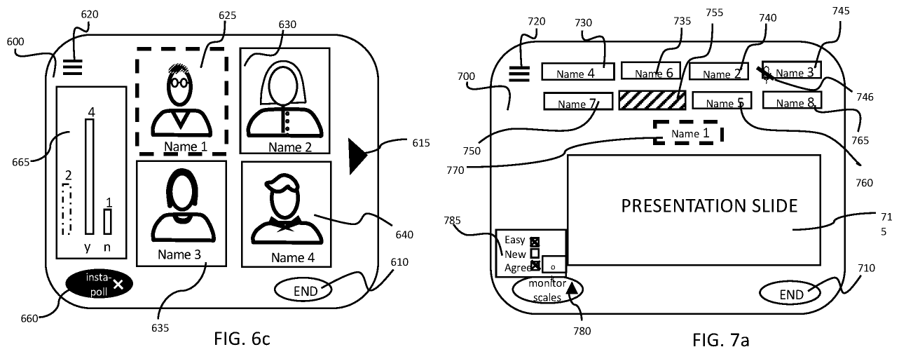

FIG. 6 shows the first embodiment of the invention. The embodiment teaches conducting a lightweight poll during a virtual meeting. According to the embodiment, a participant in a meeting can initiate a poll, in which a question is asked verbally, and responses are provided by other participants in the meeting by choosing an item from pop-up dialogue boxes displayed on the participants' displays. The responses are presented to the poll initiator as an integrated anonymous representation. Therefore, the embodiment teaches enabling a user of an electronic device to make electronic devices of other participants in a meeting display a “generic question response” screen object, which object does not include a question (a question is asked by a user verbally) and provides generic response options, suitable for answering a range of questions (such as “yes” and “no”). The responses provided of other users are being collected and displayed (preferably, collated and anonymized) to the poll initiator. The responses may or may not be shared with other users.

Essentially, a method is provided, wherein substantially at the time of performing a feedback-requesting user action a first user provides a verbal feedback-requesting instruction, using an audio or a video communication channel, to an at least second user; and

wherein said response panel displayed on said electronic device of said at least second user is disabled substantially after said at least second user uses said panel to provide information requested by said first user.

FIG. 6a shows window 600 of a computing device, representing the perspective of user “Name 1”. Window 600 shows button 610, button 620, window elements (panes) 625, 630, 635, and 640 (displaying, respectively, participant views of participants “Name 1”, “Name 2”, “Name 3”, and “Name 4”), as well as button 660 (“Insta-poll”). Button 610 and button 620 are functionally identical to buttons 110 and 120, shown in FIGS. 1-4: activating buttons 610 and 620 results, respectively, in ending the meeting and choosing the level of detail when displaying participants view in window 600. Window elements (panes) 625, 630, 635, and 640 are shown with high level of detail (resolution). The level of detail is selected by choosing “Large pics” on menu 620. Button 615 is displayed in the right-hand part of window 600, indicating that more participant views can be displayed in window 600 by activating button 615 (which results in scrolling participant views to the right). Button 660 can be activated by participant “Name 1” to elicit responses from other participants in the meeting. Preferably, the button is activated after participant “Name 1” asks a question by talking to (orally addressing) other participants or showing a screen-shared image.

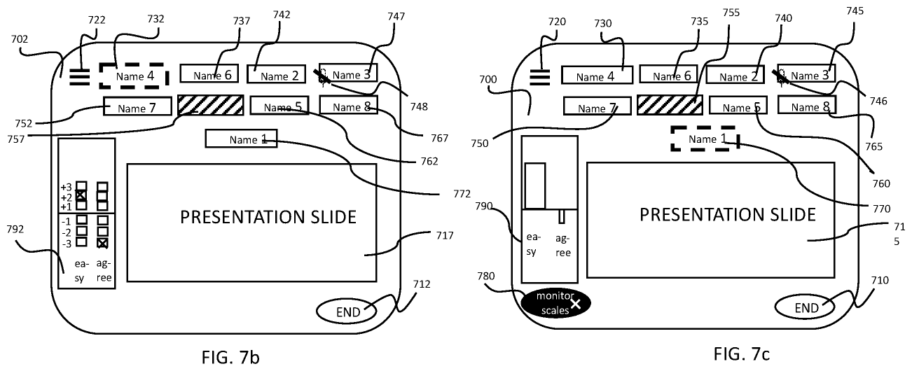

FIG. 6b shows window 602 as it is viewed by meeting participant “Name 3”, after participant “Name 1” had asked their question and clicked button 660 (see FIG. 7a). Window 602 shows button 612, button 622, window elements (panes) 627, 632, 637, and 642 (displaying, respectively, participant views of participants “Name 1”, “Name 2”, “Name 3”, and “Name 4”), as well as pop-up screen panel 652 containing screen buttons 653 (“Yes”) and 654 (“No”). Button 612 and button 622 are functionally identical to buttons 110 and 120, shown in FIGS. 1-4: activating buttons 612 and 622 results, respectively, in ending the meeting and choosing the level of detail when displaying participants view in window 600. Window elements (panes) 627, 632, 637, and 642 are shown with high level of detail (resolution). The level of detail is selected by choosing “Large pics” on menu 622. Button 617 is displayed in the right-hand part of window 602, indicating that more participant views can be displayed in window 602 by activating button 617 (which results in the participant views scrolling to the right). To answer the poll question, asked by participant “Name 1”, participant “Name 3” can activate either button 653 or button 654, after which panel 652 disappears (that is, it is no longer displayed in window 602).

FIG. 6c shows window 600 of participant “Name 1” after five out of seven other meeting participants answered the question posed by participant “Name 1”. The other participants provided their responses by using screen panels of the type of panel 652, shown in FIG. 6b. FIG. 6c is similar to FIG. 6a, with the following differences:
(a) window 600 displays panel 665, which panel shows a summary of the responses received from other participants; panel 665 indicates that 4 participants answered “yes”, 1 participant answered “no”, and 2 participants haven't answered yet,
(b) button 660 is highlighted and contains a small cross image; clicking the button makes panel 665 disappear and changed the appearance of button 660 to what is shown in FIG. 6a. If response panels, such as panel 652 displayed to participant “Name 4” (see FIG. 6b), are still displayed to some of the participants, all such panels disappear (are not displayed any longer).

It is understood that numerous variations of the third embodiment are obvious to those skilled in the art and are in the scope of the present invention. Various types of questions can be used, such as real time oral, by playing a video, by showing a written text or another image, etc. The person initiating the poll may or may not be included in the set of respondents. The polls are preferably anonymous but can also be non-anonymous. Various types of response options on the response panel, provided to the participants, can be used, not only Yes/No, as in FIG. 6, but also Yes/No/Maybe, Yes/No/Abstain, a set of numbered options asking a person to enter an appropriate number, or a scale (e.g., asking a respondent whether she/he agrees with a certain statement and providing a scale from “−3” to “+3”). Poll initiators may be enabled to choose a response panel from a predefined set or construct their own response panel or panels. Furthermore, poll initiators may be able to edit a response panel immediately before distributing the response panel to the participants (e.g., a poll initiating action may cause first displaying a response panel template, with pre-checked options, such as “yes” and “no”, on the poll initiator's display, so that the poll initiator would be able to edit the response panel, for instance, by additionally checking a “maybe” option, before issuing a command, which would cause displaying the response panel on other participants' displays). Various types of response summaries can be presented to the poll initiator, not only bar charts, but also pie charts, tables, etc. Poll results may or may not be presented to meeting participants, who are not poll initiators. Participants' devices may or may not include video cameras.

FIG. 7 shows the second embodiment of the invention. The embodiment teaches enabling content-consuming meeting participants (e.g., students) to provide continuous feedback on the content presented by a content-presenting meeting participant (e.g., a lector). According to the embodiment, a content presented by a content-presenting participant in a meeting can be assessed by other participants in real time according to certain assessment indicators, e.g., using a scale or scales. Essentially, a method is provided, wherein a response panel is substantially continuously displayed on an electronic device of an at least second user during at least a part of a teleconference session, enabling said at least second user, to continuously provide responses during said at least part of said teleconference, at time or times of own choosing, to dynamically assess at least an aspect of said teleconference session;

wherein said assessment responses are collated and continuously displayed on said display of said first user.

FIG. 7a shows window 700 of a computing device, representing the perspective of user “Name 1”. Window 700 shows button 710, button 720, window elements (panes) 730, 735, 740, 745, 750, 760, 765, and 770 (displaying, respectively, participant views of participants “Name 4”, “Name 6”, “Name 2”, “Name 3”, “Name 7”, “Name 5”, and “Name 1”), window element 755 displaying a placeholder, as well as screen button 780 (“Monitor. scales”). Visual cue 746 displayed in substantially window element 745 indicates that participant “Name 3” is muted. Button 710 and button 720 are functionally identical to buttons 110 and 120, shown in FIGS. 1-4: activating buttons 710 and 720 results, respectively, in ending the meeting and choosing the level of detail when displaying participants view in window 700. Window elements (panes) 730, 735, 740, 745, 750, 760, 765, and 770 show participant views with participant names, but not images. The level of detail is selected by choosing “Names” on menu 720. Screen area 715 displays a screen-shared image (“PRESENTATION SLIDE”).

Activating screen button 780 causes pop-up panel 785 to be displayed. The panel allows the user to select a set of scales (using a predefined set of checkboxes) and then request other participants to provide continuous assessment using the selected scales by activating the “ok” button. When the “ok” button is activated, panel 785 stops being displayed, and button changes appearance as shown in FIG. 7c.

FIG. 7b shows window 702 as it is viewed by meeting participant “Name 4”, after participant “Name 1” has initiated continuous assessment by clicking “ok” button on panel 785. Window 702 shows button 712, button 722, window elements (panes) 732, 737, 742, 747, 752, 762, 767, and 772 (displaying, respectively, participant views of participants “Name 4”, “Name 6”, “Name 2”, “Name 3”, “Name 7”, “Name 5”, and “Name 1”), window element 757 displaying a placeholder, as well as panel 792 displaying two scales: “easy” and “agree”. Visual cue 748 displayed in substantially window element 747 indicates that participant “Name 3” is muted. Button 712 and button 722 are functionally identical to buttons 110 and 120, shown in FIGS. 1-4: activating buttons 712 and 722 results, respectively, in ending the meeting and choosing the level of detail when displaying participants view in window 702.

Panel 792 is displayed to meeting participants, except for participant “Name 1”, when participant “Name 1” clicks button “ok” on their panel 785. Panel 792 shows two vertical scales, “easy” and “agree”. Each scale is presented by 6 checkboxes, corresponding to values from “−3” to “+3”. To set a score on a scale the user clicks or taps on an appropriate checkbox. FIG. 7b shows two checkboxes selected by participant “Name 4”: “+2” for “easy” (i.e., participant “Name 4” thinks the content is rather easy to understand) and “−3” for “agree” (i.e., participant “Name 4” strongly disagrees). When a checkbox is selected, a score is communicated to participant “Name 1” (e.g., via a server), and the selected checkbox is marked with an “X” for 2 seconds. After that the marking disappears and the scale is reset to “no score”. Participants themselves decide when (and if) they want to express their assessment of the content. It is understood that the assessments are related to the currently presented content, rather than the presentation as a whole. A participant can provide as many (or as few) scores as they wish.

FIG. 7c shows window 700 of participant “Name 1” after several other meeting participants entered their scores using on-screen panels of the type of panel 792, shown in FIG. 7b. FIG. 7c is similar to FIG. 7a, with the following differences:
(a) window 700 displays panel 790, which panel shows a summary of the scores, which are being currently received from other participants, as a bar chart. The height of a bar indicates the average score, and the width of a bar indicates how many people provided their scores. Panel 790 shown in FIG. 7c indicates that many participants think the current content is easy to understand, and a small number of participants express their disagreement with the content.
(b) button 780 is highlighted and contains a small cross image; clicking the button makes panel 780 disappear, and the appearance of button 780 is changed to what is shown in FIG. 7a. Scale panels displayed to other participants, such as panel 792 displayed to participant “Name 4”, disappear (are not displayed any longer).

It is understood that numerous variations of the second embodiment are obvious to those skilled in the art and are in the scope of the present invention. Various types of assessment attributes and criteria can be used: difficulty to understand, logical inconsistency, how convincing the arguments are, engagement, novelty of the material, etc. The assessments are preferably anonymous but can also be non-anonymous. Individual participants, as they are shown to the feedback—receiving participant (e.g., a speaker or a teacher) may be marked with visual clues if non-anonymous responses are provided: for instance, students' avatars or video panes, as they are viewed by the teacher, can be colored depending on students' answers (e.g., red in case of negative feedback and green in case of positive feedback). Various types of response options on the response panel, provided to the participants, can be used, not only the scales shown in FIG. 7, but also, for instance, simple buttons (e.g., “Unclear” or “Old material”). Assessment initiators may be enabled to choose a response panel from a predefined set or construct their own response panel or panels. Response panels may be always on rather than being activated/deactivated by the assessment initiator. Various types of response summaries can be presented to the assessment initiator, not only bar charts, but also pie charts, tables, etc. Assessment results may only be presented to assessment initiators, but they may also be presented to other meeting participants. An assessment input, provided by a respondent, may be auto reset to a “no input” value (immediately or after a predetermined amount of time) or stay unchanged until the next input provided by the respondent.

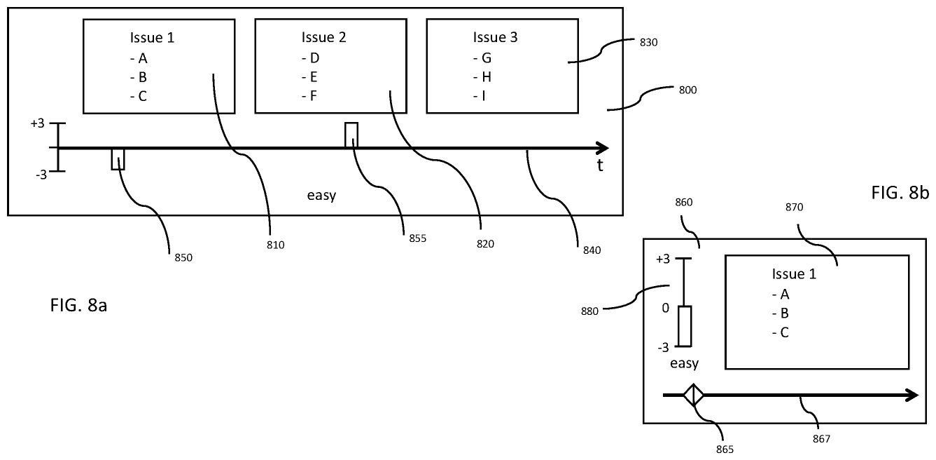

The dynamics of assessment results over the course of a meeting (or a part of a meeting), can be recorded and compared and/or correlated with a wide range of potential other recorded timestamped data concerning the meeting (or the part of the meeting), such as video/audio recording of the meeting, the sequence of presentation slides (e.g., which slides were assessed as “Hard to understand”), chat messages posted, breakout rooms initiated, and so forth. The data can be used to create a combined visual representation, which displays, on the same timeline, both (a) the dynamics of the scores and (b) particular recorded events taking place during the meeting. Such representations can be used, for instance, to reflect upon how the participants assess their experience regarding the material presented to them during the virtual meeting. That ramification of the second embodiment is illustrated by FIG. 8. FIG. 8a shows a combined representation 800, which places slides 810, 820, and 830 on the same timeline 840 as assessment scores 850 and 855. Representation 800 shows that negative feedback was provided when slide 810 was displayed and positive feedback was provided when slide 820 was displayed. A variant of the representation is shown in FIG. 8a. Display window 860 having slider 865, which slider can be moved along timeline 867 to select a certain point of time (or a certain time interval) during the virtual meeting in question. When the point or interval is selected, window 860 displays presentation slide 870, shown at that point during the meeting, as well as assessment 880, which is a feedback provided at that time.

Essentially, a method is provided, wherein continuously provided user responses are recorded and employed to produce an image comprising first visual objects representing said continuously provided responses and second visual objects representing at least a type of information, said at least type of information selected from a group comprising at least: video and audio recordings of said virtual meeting, screen-shared images, and participants action, such as chat message postings, floor requests, and reactions/visual feedback, wherein said first visual objects and said second visual objects are presented along a timeline of said teleconference session.

It is understood that FIGS. 1, 6, 7, and 8 are used by way of illustration, and not limitation. Various additional variations are obvious to those skilled in the art and are therefore within the scope of the present invention: While the current disclosure concerns virtual meetings, it is obvious to those skilled in the art that the scope of the invention covers all kind of communication sessions, including, for instance, non-interactive lectures. Various kinds of devices can be used in accordance with the present invention, including (but not limited to) desktop computers, laptop computers, smartphones, and tablet computers. Such devices may comprise various, such as displays, microphones, memory storages, processors, input devices, and so forth. They may or may not include video cameras. The components can be either built in or externally connected. Memory storage and data processing according to the present invention may be distributed between user devices and a server or servers, connected via a communication network.

What is claimed is:

1. A method is provided for supporting a plurality of users using a plurality of electronic devices to engage in a teleconference session, said plurality of users comprises a first user and at least a second user, and said plurality of electronic devices comprises a first device used by said first user and at least a second device used by said at least second user, wherein each device in said plurality of devices comprises at least a processor, a display, said display displaying an at least a display window, a microphone, wherein said plurality of devices are connected via a communication network to one another and preferably to a network server or servers, the method comprising the method steps of
detecting a feedback-requesting user action performed by said first user, said user action being a request for information from said at least second user, said requesting user action being performed either before or during said teleconference session; wherein said requesting user action causes displaying a response screen panel on said electronic device of said at least second user; wherein said response panel is adapted to be used by said at least second user to provide information requested by said first user; and
transmitting information collected through the use of said response panel from said at least electronic device used by said at least second user to said electronic device used by said first user users; and
presenting said transmitted information on said electronic device used by said first user.

2. A method of claim 1, wherein at least one of said plurality of devices comprises a video camera.

3. A method of claim 2, wherein substantially at the time of performing said feedback-requesting user action said first user provides a verbal feedback-requesting instruction, using an audio or a video communication channel, to said at least second user; and
wherein said response panel displayed on said electronic device of said at least second user is disabled substantially after said at least second user uses said panel to provide information requested by said first user.

4. A method of claim 2, wherein said response panel is substantially continuously displayed on said electronic device of said at least second user during at least a part of said teleconference session, enabling said at least second user, to continuously provide responses during said at least part of said teleconference, at time or times of own choosing, to dynamically assess at least an aspect of said teleconference session;
wherein said assessment responses are collated and continuously displayed on said display of said first user.

5. A method of claim 4, wherein said continuously provided responses are recorded and employed to produce an image comprising first visual objects representing said continuously provided responses and second visual objects representing at least a type of information, said at least type of information selected from a group comprising at least: video and audio recordings of said virtual meeting, screen-shared images, and participants action, such as chat message postings, floor requests, and reactions/visual feedback, wherein said first visual objects and said second visual objects are presented along a timeline of said teleconference session.

6. A non-transitory computer-readable medium containing instructions, which, when executed by a processor, cause a first electronic device used by a first user, said first device comprising at least a processor, a memory storage, a display, and a microphone and a video camera, said device being connected via a communication network to a plurality of other electronic devices, connected to at least a network server, used by a plurality of other users taking part in a teleconference session (and preferably also), to perform functions of:
detecting a user action performed by a user of said first device, said user action being a request for feedback directed to said plurality of other users; wherein said requesting user action comprises distributing to said plurality of other devices a response panel to be used by said other users to provide information to said first user; and
transmitting said information provided by said plurality of other devices to said first electronic device; and
collating and displaying said information on said first electronic device.

7. A non-transitory computer-readable medium of claim 6, further containing instructions, which, when executed by a processor, cause said first electronic device to perform functions of:
enabling a user of said first device to verbally ask a question to said other users of said plurality of other electronic devices;
wherein said response panel comprises response options for answering a range of various questions (such as “yes” and “no”).

7. A non-transitory computer-readable medium of claim 6, further containing instructions, which, when executed by a processor, cause said first electronic device to perform functions of:
cause a response panel, enabling users of said other devices to substantially continuously provide responses during at least a part of said teleconference session at time or times of their choosing, to be displayed on said other devices; and
substantially continuously displaying said responses on said display of said first user.
